(19) United States
(12) Patent Application Publication
(10) Pub. No.: US 2015/0306501 A1
(43) Pub. Date: Oct. 29, 2015

(54) MOBILE DEVICE GAME FOR CROWD-SOURCING ITEMS

(71) Applicant: ACT, Inc., Iowa City, IA (US)

(72) Inventors: L. Miguel Encarnacao, Coralville, IA (US); Zachary Arenson, Iowa City, IA (US)

(73) Assignee: ACT, Inc., Iowa City, IA (US)

(21) Appl. No.: 14/260,892

(22) Filed: Apr. 24, 2014

(51) Int. Cl. A63F 13/5375; A63F 13/46; G06F 17/30

(52) U.S. Cl. CPC A63F 13/5375; G06F 17/30277; A63F 13/46

(57) ABSTRACT

The present invention provides a gaming platform and method, such as a mobile game and method, for crowd-sourcing one or more items of interest. One aspect is a gaming platform and method for crowd-sourcing one or more items of interest by matching a visual representation to a prompt using a mobile or electronic device. Queries are displayed to a player and an image representative of the query is acquired. A time period for the image to score is allocated. Points may be awarded to the player. Crowd-sourced items may be analyzed to determine public bias, perception and misconception.

### BACKGROUND OF THE INVENTION

I. Field of the Invention

The present invention relates to a game for crowd-sourcing items of interest. More specifically, but not exclusively, the present invention relates to a mobile game and method for crowd-sourcing items for item study, development and research.

II. Description of the Prior Art

Evaluation of items of interest by a public crowd is valuable in many regards. Public perception of correctness and relevancy of one or more items of interest can be had through crowd-sourcing.

Therefore, it is an object, feature, or advantage of the present invention to provide one or more platforms for crowd-sourcing items of interest, where the platform is easily socially integratable, trends with social interests and has ongoing public appeal.

Identifying methods and processes for increasing the amount or number of any kind of items in the real-world, including but not limited to artistic, creative, job/skill representations, and group/team behaviors can be challenging, costly and command a lot of resources. Similarly, increasing item counts for various subject areas, such as Science, Technology, Engineering or Math (“STEM”)-related items, is not without challenges and difficulties.

Therefore, it is an object, feature, or advantage of the present invention to provide a platform for producing items of interest, including for example real-world and STEM-related items at very little or even no cost.

In addition to the development challenges, researching items of interest, real-world items, STEM-related items or others can poses significant hurdles. Resolving issues, such as public bias, perception and misconception, can be costly, time consuming and command an inordinate amount of resources.

Therefore, another object, feature, or advantage of the present invention is provide a platform for researching items of interest, whether real-world items, STEM-related items, or other like items that is inexpensive and capable of readily identifying public bias, perception and misconception, and thus improve item study, development and research in the process.

Another object, feature, or advantage of the present invention is to provide a mobile platform for crowd-sourcing items of interest for evaluation by a public crowd for correctness.

Identifying items that are relevant and of interest is a challenge faced in real-world item development and particularly in educational item development. In addition to the above challenges, other prevailing rigors include making and keeping item topics relevant to the public, students and others—thereby creating and/or preserving its excitement.

Therefore, a still further object, feature, or advantage of the present invention is to provide a mobile gaming platform that achieves all of the above-identified objectives while keeping item topics exciting and relevant to todays' public, students and others.

One or more of these and/or other objects, features or advantages of the present invention will become apparent from the specification and claims that follow.

### SUMMARY OF THE INVENTION

The present invention provides a mobile gaming platform for crowd-sourcing one or more items of interest.

One exemplary embodiment provides a method for picture and question matching for a mobile device. According to one aspect, a query is presented to a player, such as via a mobile device. The player is then instructed to acquire a visual representation of the query, such as an image, photo or video. The player may also be notified of a time period for the visual representation of the query to score points. Points may be awarded to the player at least in part upon another player successfully matching the visual representation of the query with the corresponding alphanumeric representation of the query. In another aspect, a player could be presented with a visual representation of a query and invited to identify the corresponding alphanumeric representation.

Another embodiment provides a method for crowd-sourcing a picture (e.g., image, photo, video, etc.) and question (e.g., query) matching game, such as for a mobile device. According to one aspect, a player profile is created. A query is provided via a mobile device and a visual representation of the query is captured. Time remaining for scoring based on the combination of the query and visual representation of the query may be incremented when the query and the visual representation of the query are matched together by another player.

Yet another embodiment provides a picture (e.g., image, photo, video, etc.) and question (e.g., query) matching game, such as for a mobile device. The mobile game includes a query (e.g., alphanumeric representation of a query) that is displayed to a player via the mobile device. A visual representation of the query that best represents an alphanumeric representation of the query is acquired by the player. A time period for the player's selection to score is allocated to the player. One or more points may be awarded to the player based at least in part upon another player successfully matching the visual representation of the query with the corresponding alphanumeric representation of the query.

### BRIEF DESCRIPTION OF THE DRAWINGS

Illustrated embodiments of the present invention are described in detail below with reference to the attached drawing figures, which are incorporated by reference herein, and where:

FIGS. 1A-B are pictorial representations of a flow diagram in accordance with an illustrative embodiment;

FIG. 2 is a pictorial representation of another flow diagram in accordance with an illustrative embodiment;

FIGS. 3A-D are pictorial representations of a series of screenshots in accordance with an illustrative embodiment;

FIG. 4 is a pictorial representation of a communications environment in accordance with an illustrative embodiment; and

FIG. 5 is a pictorial representation of a block diagram for a network and system in which an embodiment of the invention may be implemented in accordance with an illustrative embodiment.

### DETAILED DESCRIPTION OF THE PREFERRED EMBODIMENTS

A game, system and method, such as a mobile game, system and method, for crowd-sourcing items of interest is provided. Items of interest can range and include real-world items. Although not intended to be an exclusive list, some real-world items include, but are not limited to, artistic, creative, job/skill representations, and group/team behavioral items. One specific item category of interest includes STEM-related items and item content. Other specific item categories are also contemplated as further specified throughout the present disclosure or as generally understood to be items or item content of real-world interest.

In at least one aspect of the present disclosure, a mobile game, using a mobile device, preferably a camera enabled mobile device, is provided for crowd-sourcing items of interest, such as one or more real-world items in the form of a visual representation of a query (e.g., images, photos/photographs, video (with or without audio), etc.) and associated with a query (e.g., question, or problem statement, or otherwise an alphanumeric representation of a query). According to one practical embodiment, STEM-related items are crowd-sourced in the form of a visual representation of a query and associated with STEM queries for subsequent test studies, development and research. Beneficially, new real-world item content/ideas are produced at literally no cost, while on the research side, a mobile game platform aids in identifying public bias, perception and misconception and thus improved studies, development and research in the process. Therefore, a process and mobile game implementation, that captures an individual's understanding of items of interest, such as real-world items, including STEM items, together with visual representations of a query provided by those individuals which is then evaluated by a public crowd for correctness and popularity purposes is provided. Additional mechanisms to monitor and otherwise assess the quality of exchanging items of interest, real-world items/content and specifically STEM-related visual representations of a query may also be implemented.

In one particular application of the present disclosure, challenges exist to increase the amount of items, such as STEM-related items, for various subject areas. At the same time, education (e.g., STEM education) has a challenge of making topics (e.g., STEM or educational topics) relevant to students and growing excitement around such topics. Additionally, finding ways to draw students into a business's STEM or educational item profile can be challenging. Therefore, a mobile gaming device and platform for crowd-sourcing STEM and other educational-related items for test studies, development and research are of interest, particularly as it relates to the use of mobile devices, namely smartphones and other camera enabled electronic devices, which have ubiquitous use amongst students and rapid adaptation and adoption given their proclivity and passion for taking photographs and playing electronic games.

To address the challenges identified above as to at least one aspect of the present disclosure, a mobile gaming platform and method for crowd-sourcing STEM and educational-related items for test development and research is provided. According to one exemplary embodiment, a player (also known as a “user”) may be invited or asked to acquire a visual representation of a query (e.g., photo, image, photograph, video, etc.) that best illustrates, relates to or otherwise has a correlation to a query (e.g., STEM or educational-related question, or otherwise an alphanumeric representation of a query) that they have chosen. The acquired visual representation of the query is then communicated to an image bank (e.g., a data storage for storing a plurality of visual representations) where any other user from any other network can choose and subsequently try and answer a query that is best representative of the visual representation of the query. From there, the user may be brought to the image bank and given a choice of query visual representations to choose from. Once a visual representation of the query is selected the player chooses the query that they think the image (i.e., visual representation of the query) best represents. If answered correctly the user may be awarded points. Finally, the player is brought to a player profile where they can monitor current and old posts that they have created from selected queries and the accompanying visual representations. Posts are on a timer according to one aspect of the invention; the timer can be increased or incremented every time another player chooses their post and for correct answers. In addition, time points may be awarded to a player for every correct answer their post accumulates. In one aspect, once the time for a post runs out the post is no longer available as an option for other users or players to pick and points are no longer able to be obtained from that specific post.

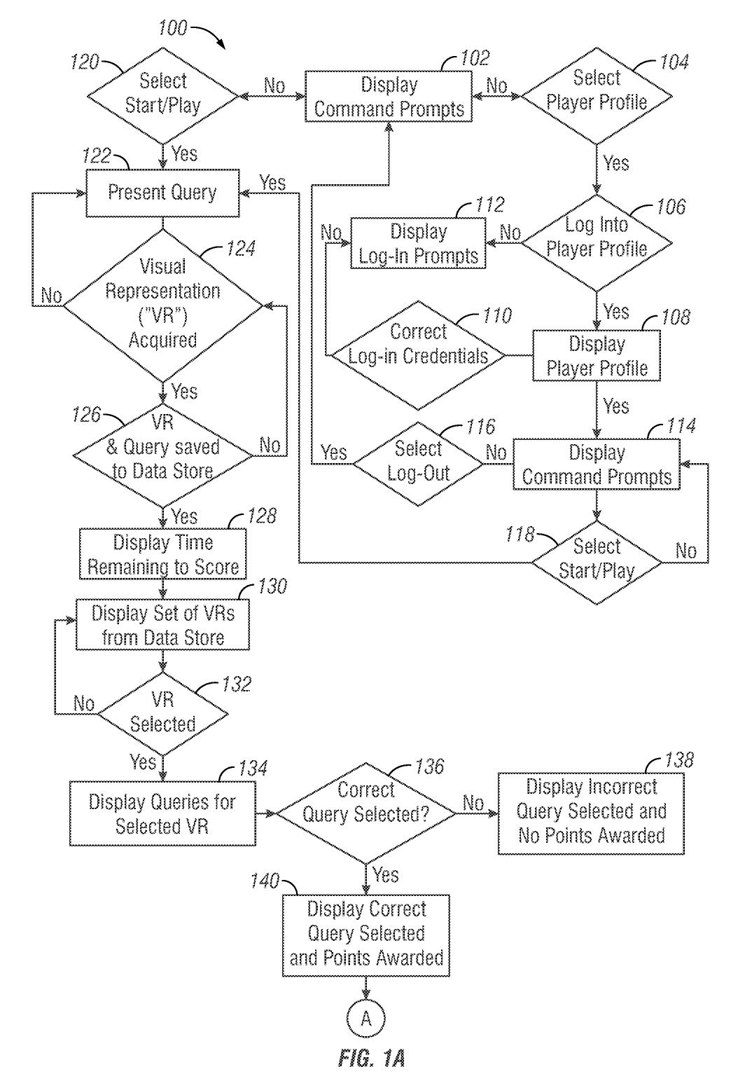

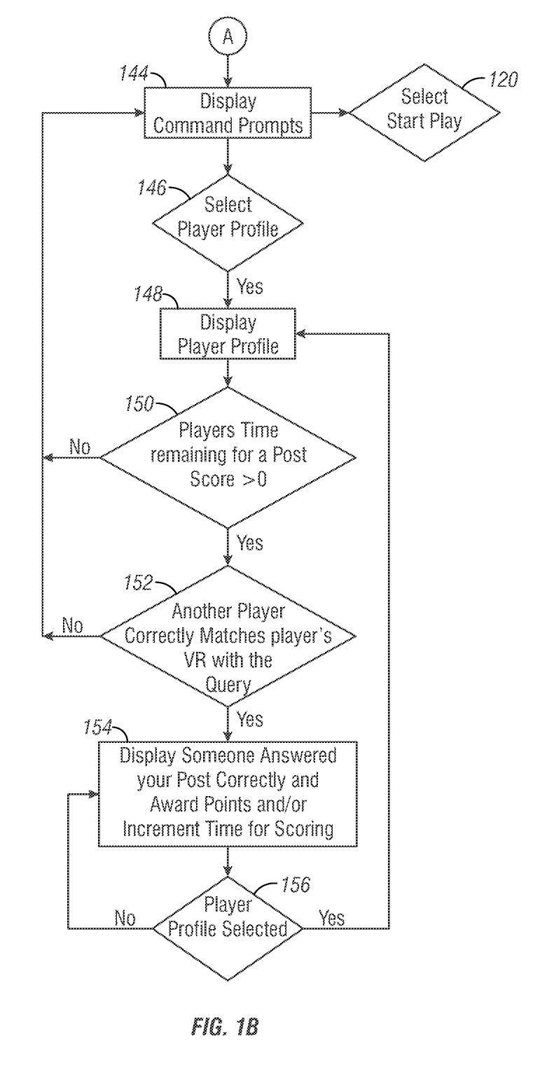

An exemplary processes and methods of the present disclosure are illustrated pictorially in FIGS. 1A-1B. The process 100 and method may be implemented, operated or otherwise performed on an electronic device, such as a camera enabled smartphone, or on a network in communication with one or more electronic devices. Other platforms of use include any electronics with imaging software, hardware or components suitable for capturing or identifying visual representations of a query. This could include, for example, mobile devices and stationary computers with a webcam. Embodiments may be implemented at least in part as hardware embodiments, software embodiments, (e.g., program, instructions, “app”, kernel, operating system, script, add-on, etc.) or as a combination of hardware, software, and/or firmware. The illustrative embodiments may at least in part be implemented by commercially available, dedicated, or semi-dedicated devices. The described methods, embodiments, components and features may be utilized or combined in any number of combinations and these diverse embodiments are envisioned. Unless otherwise indicated, as used herein, “or” does not require mutual exclusivity.

Embodiments may be performed, implemented or otherwise operated on a wireless device receiving and transmitting a wireless signal. An electronic device, such as a wireless device, may represent cellphones, radios, smartphones, a Blackberry device, an iPad, an iPhone, a Windows mobile phone, an Android phone, or other camera enabled computing or communication devices. The devices may include dedicated hardware and/or software for performing one or more operations of the present invention. A wireless signal may represent a radio frequency, light or wireless signals, such as a cellular signal (GSM, PCS, digital, etc.), designated or allowed radio signal or spectrum (3 Hz-30 GHz, family radio service (FRS), general mobile radio service (GMRS), multi-use radio service (MURS), ham Citizen's Band (CB), ultra-high frequency (UHF), Bluetooth, ZigBee, ultra-wide band, wireless USB, infrared, wireless local area network (WLAN), Wi-Fi, wiMAX, proprietary standards, or other radio frequency signals whether analog or digital that may be utilized to communicate a signal. Any number of FCC, FDA, IEEE, ISO, CEN, ETSI, Arib, and CANSI, or IEC approved or developing communication standards, signals, or protocols may also be used. The wireless signals may or may not require a FCC or other government or industrial applicable license. In one embodiment, each frequency within a band may be associated with one or more functions, operations or processes of the present invention. In another embodiment, the wireless signal may be include packets, encryption, or other encapsulated signals or may represent frequency broadcasts.

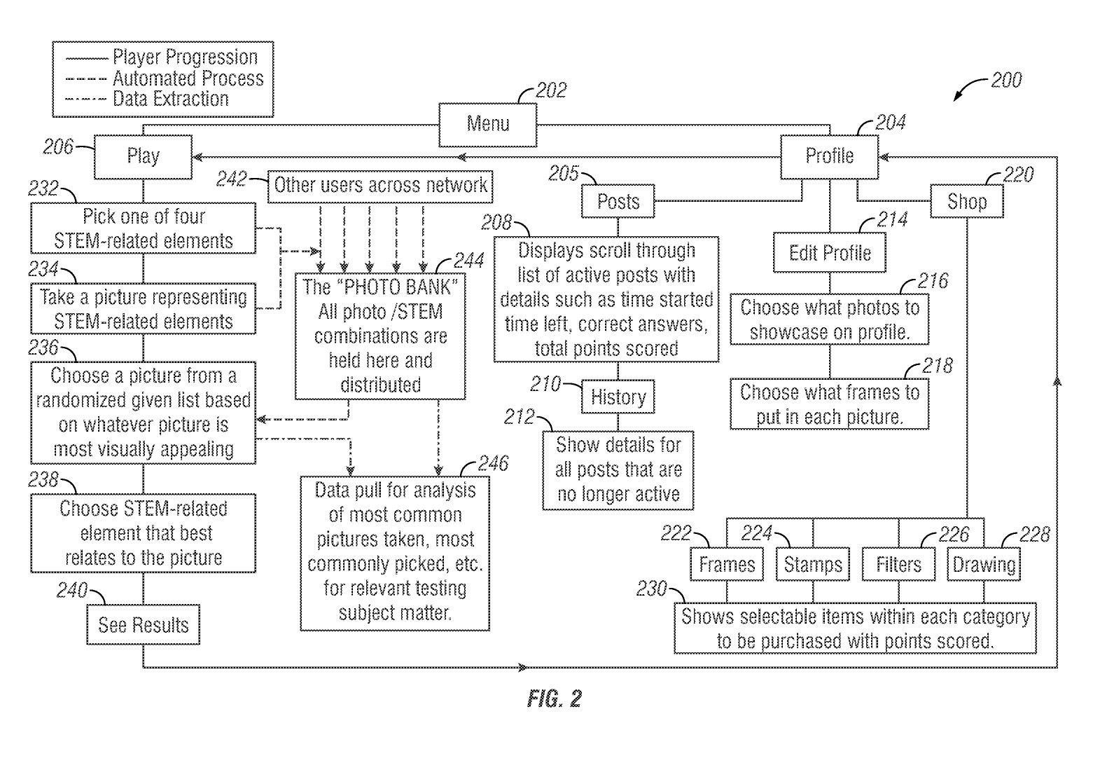

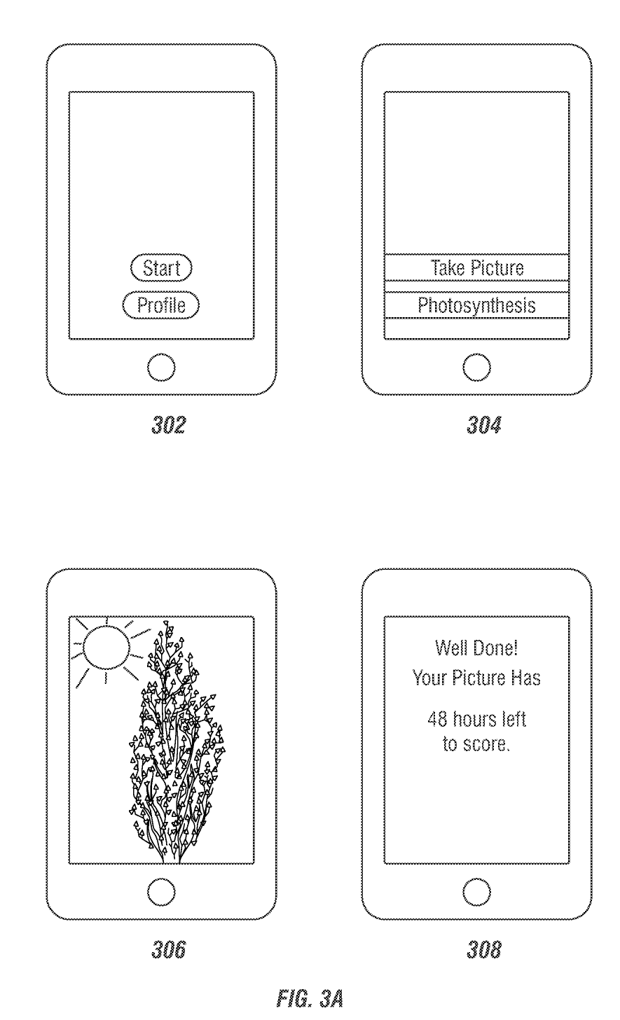

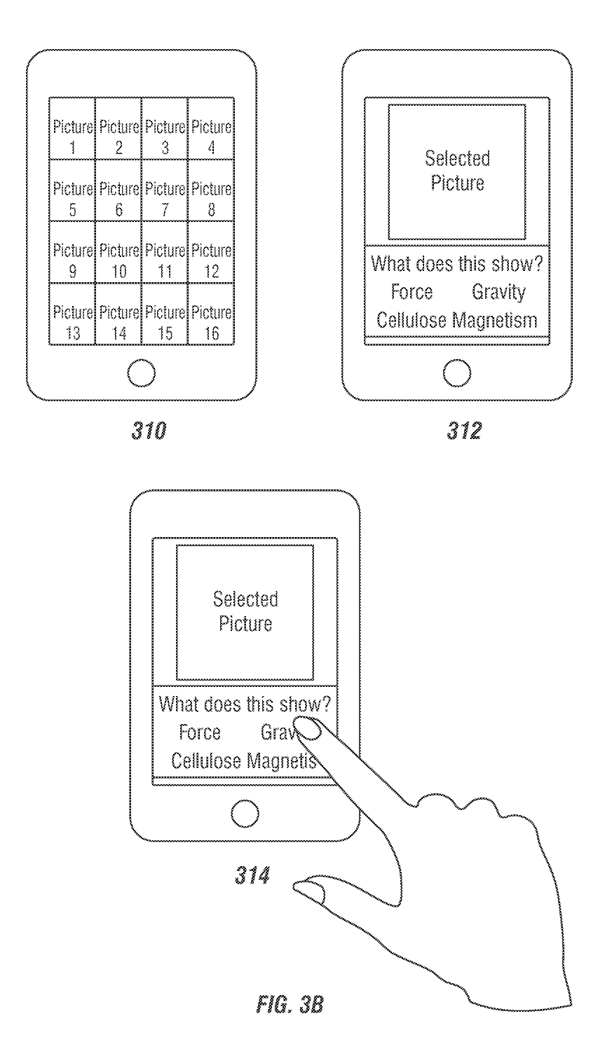

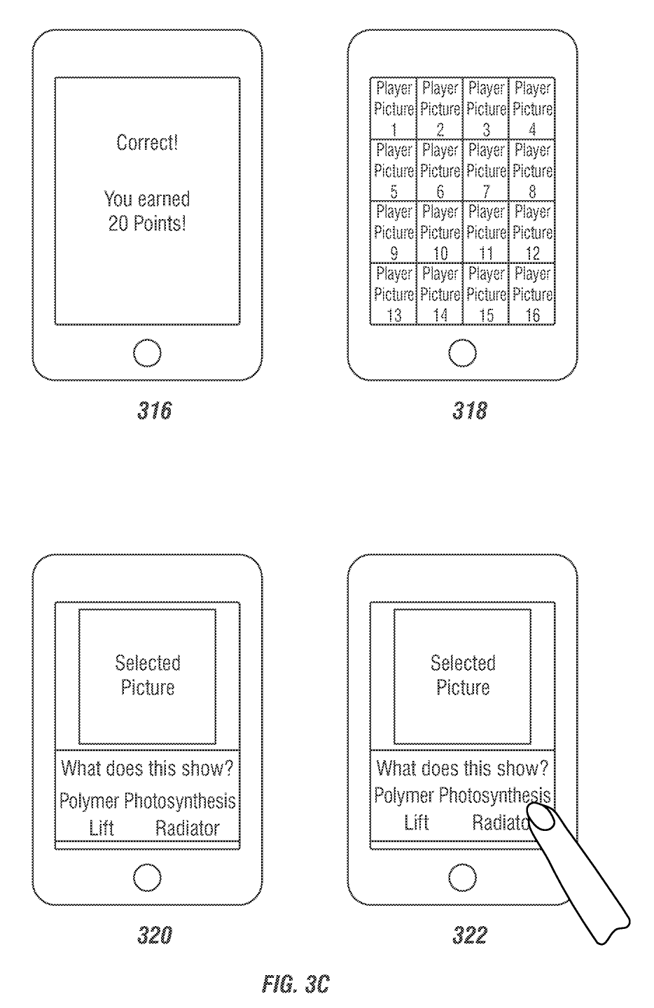

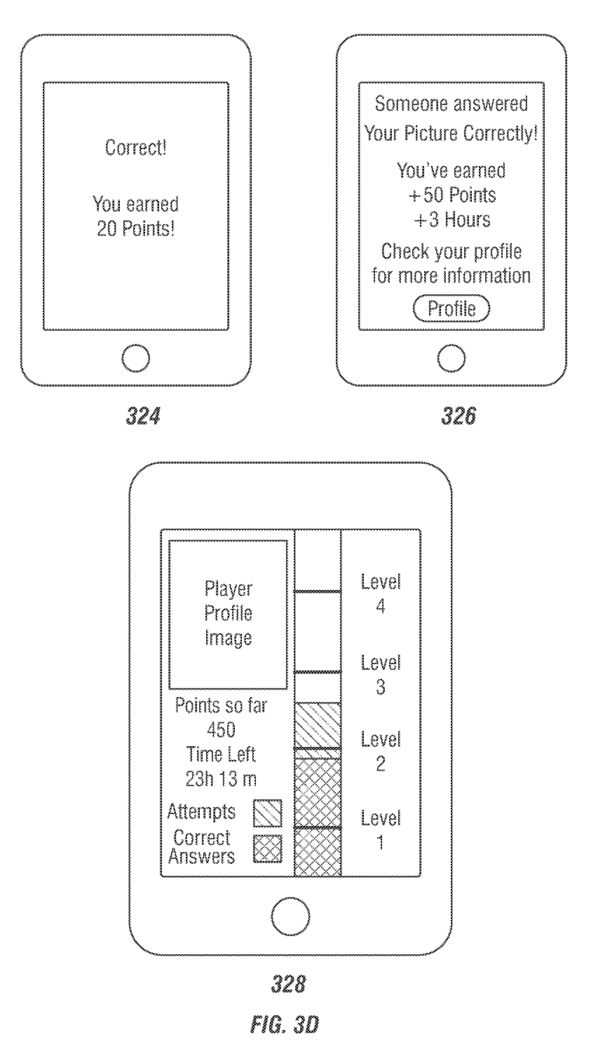

According to another aspect, an application may be executed by an electronic device, such as a camera enabled wireless device, to perform the communications as herein described. In other embodiments, the operating system, kernel, an application specific integrated circuit (ASIC), field programmable gate array (FPGA), or other hardware (e.g., digital logic) of the wireless device may perform the communications, features, and/or functions/processes as described. As illustrated pictorially at 102 in FIG. 1A, command prompts are displayed, for example, using an electronic device, such as a camera enabled wireless device. Command prompts may be displayed as an image, video, text, or presented to a player as audio. Command prompts may be selected by a player or user by verbal command or by selection from one or more pictorial illustrations on a screen, such as a touchscreen display of a computing or electronic device. As illustrated by screenshot 302 in FIG. 3A, the device, such as a computing or electronic device (e.g., camera enabled smartphone) may include a touch-sensitive display (also known as a “touchscreen”) with a graphical user interface (GUI), one or more processors, memory and one or more modules, programs or sets of instructions stored in the memory for performing multiple functions. In some embodiments, the user or player interacts with the graphical user interface primarily through finger contacts and gestures on the touch-sensitive display. In some embodiments, the functions may include speaking into the electronic device for performing one or more of the functions, processes or operations of the present invention. Instructions for performing one or more of the functions, processes or operations of the present invention may be included in a computer readable storage medium or other computer program or product configured for execution by one or more processors. The display may include one or more command prompts, such as a select player or select player profile command prompt 104 and/or a select start or select start play command prompt 120. A player or user may select any one of these user command prompts from the aforementioned steps, operations, or processes. An exemplary screenshot providing a display pictorially for an arrangement of command prompts is provided in FIG. 3A at screenshot 302. As represented pictorially in an example embodiment of FIG. 2, a menu screen prompt 202 may be displayed on a device for providing one or more game control options for the player to select and/or view. As illustrated, a play command prompt 206 and/or a profile command prompt 204 may be displayed on the device for a player to select. According to one aspect, a player may be able to select a play command prompt 206 from within the one or more items illustrated upon selecting the profile command prompt 204 as illustrated pictorially in FIG. 2.

Upon selection of the player profile command prompt 104 illustrated in FIG. 1A, the system may include an operating protocol that verifies whether or not the player is logged in to his or her profile (see command prompt 106). If the player has not logged into his or her profile, a command prompt or input field may be displayed for the player to input his or her log-in information, such as a username and password (see Step 112). If the correct log-in credentials are entered (see Step 110), the player's profile is displayed at Step 108. As best illustrated in FIG. 2, a player's profile 204 may include command prompts such as posts 205, edit profile 214 and shop 220. By selecting the command prompt posts 205, a player is able to view a list of all active posts with details such as the time started, time left, attempts, correct answers, total points scored which can be scrolled through on a touchscreen display, such as on an electronic or computing device. An example of a screenshot illustrating a display for at least one active post is provided at 328 in FIG. 3D. Also included within the profile command prompt 204 is a history command prompt 210 showing details for past posts, for example, that are no longer active (see Step 212).

An option/prompt to edit profile 214 may be provided within the player profile prompt 204 whereby a user or player may choose one or more user oriented, user preference or user selected options for one or more operations, processes or functions of the present invention. For example, a player may choose a photo to showcase on his or her profile (see Step 216). Other options could include, for example, selecting an artistic frame for each of the acquired pictures or images for purposes of displaying (see Step 218). Other options may be available to the player for selecting one or more variables relating to the operation environment within which one or more of the functions, processes or operations of the present invention interface with the player. A shop command prompt 220 may also be included under the profile command prompt 204. In the shop players may select from one or more items relating to a process, function or operation of the present invention. For example, a player may select from one of the following command prompts, namely frames 222, stamps 224, filters 226 and/or drawings 228 to select items within each of these categories to be purchased with acquired points (see Step 230). Any of the aforementioned command prompts may be displayed upon accessing a player's profile using one or more of the steps illustrated in FIGS. 1A-2. For example, a player's profile may be accessed by entering correct log-in credentials (see Step 110 in FIG. 1A). In addition to the command prompts discussed above, a player may have the option of selecting a log-out command prompt 116 or start/play command prompt 118 illustrated in FIG. 1A within the profile command prompt 204 illustrated in FIG. 2. Upon selecting the log-out command prompt 116, the display shows the home screen command prompts 102 in FIG. 1A, such as for example, the menu prompt 202 illustrated in FIG. 2. If however a player selects the start/play command prompt 118, such as by selecting the play command prompt 206 in FIG. 2, the player is presented with one or more queries 122 such as, for example, an item of interest, a real-world item, or a set of STEM elements as represented by way of example in Step 232 in FIG. 2. According to one aspect, a single item on aspect or a single STEM-related item in another aspect is presented to the player such as via a display of an electronic or computing device (e.g., such as a camera enabled electronic device or other device as specified or contemplated herein). A single query or a STEM-related item may be presented to the player as audio or video. Screenshot 312 in FIG. 3B provides a pictorial representation of a query such as a STEM-related item being presented via an electronic display to a player in accordance with an illustrative embodiment of the invention. Although reference is made to STEM-related items and queries, other items and queries of interest, real-world items or queries or those specifically identified or contemplated herein could be used. A query may be presented to a player at Step 122 in FIG. 1A or according to another aspect a number of STEM-related elements or queries as pictorially represented in Step 232 in FIG. 2. Items could be presented as a single query or STEM element or multiple queries/STEM elements from which one may be selected as pictorially represented at Step 232 in FIG. 2. Queries (e.g., items of interest, real-world items, STEM-related items/elements) may be displayed or presented to a player as a single word or multiple words. According to one aspect of the present invention, science, technology, engineering and math related items are presented or displayed to a player as part of a process, operation or function of the present invention. According to another aspect of the present invention, varying items of interest are presented or displayed to a player as part of a process, operation or function of the present invention. According to yet another aspect, real-world items of varying genre are presented or displayed to a player as part of a process, operation or function of the present invention.

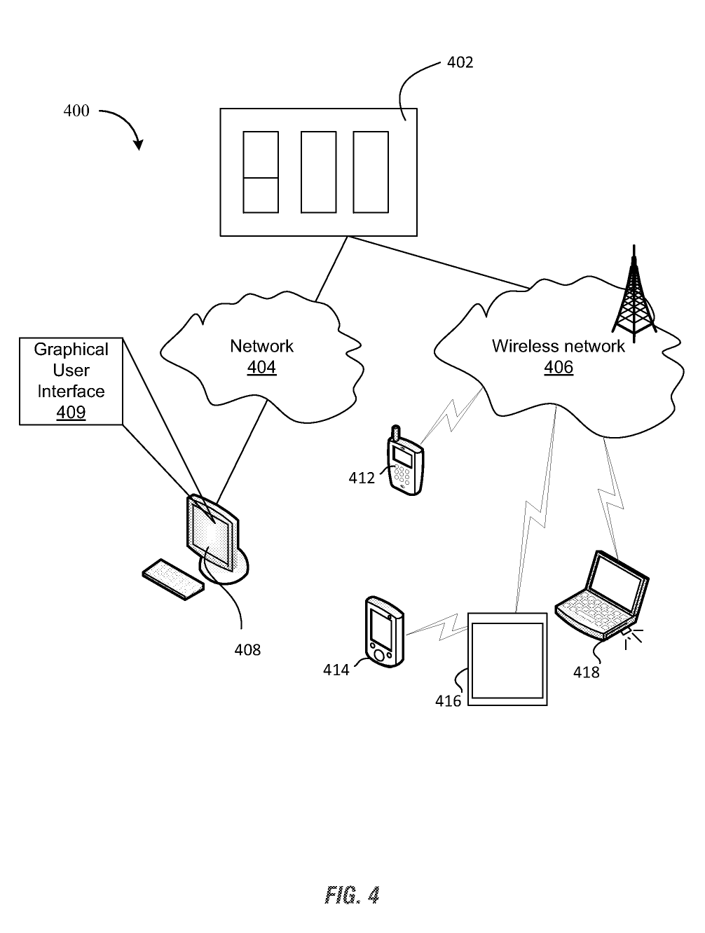

Using, for example, a camera enabled smartphone, a user or player receives a prompt via the display, video or audio to acquire (i.e., take) a photograph “best” representing the query (i.e., a visual representation (“VR”) of the query as shown in Step 124 in FIG. 1A) or a picture best representing STEM element as indicated at Step 234 in FIG. 2. By way of example, screenshot 304 provides a pictorial illustration representing an embodiment of the invention issuing a prompt to a player to acquire a picture that best represents the query or STEM item presented to the player. As previously indicated, the query may be any item of interest, any real-world item (e.g., artistic, creative, job/skill representations, and group/team behavioral representations), or a STEM-related item. Using an electronic device, such as a camera enabled electronic device, a player is able to use native operating software, hardware, firmware or other applications for acquiring an image/picture using the camera feature associated with the electronic device. Video may be captured in another aspect. An example screenshot 306 is provided in FIG. 3A providing a pictorial illustration of a photo or picture acquired using a camera enabled smartphone, where the acquired image or picture is associated with the query (i.e., is a visual representation of the query) or STEM element such as the STEM-related element/item shown by screenshot 304. If for some reason image acquisition fails (see Step 124 in FIG. 1A), the command prompt to acquire a picture (see Step 234 in FIG. 2) is displayed or may be presented to the player as audio. Upon acquisition of a visual representation (“VR”), such as an image or picture (see Step 124 in FIG. 1), the combination of the VR and query is saved to a data store also known as an image bank. As illustrated in the example of FIG. 2, the chosen picture along with the associated query or STEM element is saved in a “BANK” such as a photo/STEM bank (see Step 244 in FIG. 2) where all photo/STEM combinations are held and distributed. FIG. 4 provides a pictorial representation of a data and/or communications management system 400 that uses one or more devices, infrastructure, and platforms for enabling, initiating, routing, and managing communication between an electronic or computing device and components of the data/communication system. The system 400 illustrated in FIG. 4 may include one or more devices networked to manage the network or wireless network. For example, the data or communications management system may include any number of servers (i.e., application, database, name, proxy, web, mobile, communications, catalog, etc.), MSCs, NSSs, HLRs, BSSs, UTRANs, VLRs, routers, switches, or advanced intelligent network devices. In one aspect, the data or communications management system, network 404 and wireless network 406 may represent a cloud network system (or managing portions of a cloud network), mesh network, or server farm. The data or communications management system, network, or wireless network may also include web servers or database servers. The servers may communicate data and perform other features associated with the disclosed embodiments, such as for example, banking pictures with associated STEM elements. In another embodiment, these servers may save user profile, previous history information, preferences, selections, postings, and other authorized user content.

In one embodiment, the data/communications management system 400 may generate a portal usable by one or more devices (e.g., laptop 418, tablet 416, smartphone 414, cellphone 412, or computer 408 using graphical user interface (GUI) 409). A portal may be a website that functions as a central point of access to information on the internet or an intranet. The portal may be accessed from any electronic or computing device or communication system or device enabled to communicate through a network connection, either wirelessly or through wired connection. The portal may be utilized to receive information relating to one or more of the functions, processes or operations of the present invention. In one embodiment, the portal may be a web-based mobile application. The web-based mobile application may be useful in areas with extensive network coverage and user utilizing any number of different mobile platforms. The web-based mobile application may utilize the newest versions of language, such as HTML (e.g., five, six, etc.), CSS, JavaScript, or other similar languages.

This system determines that the image or picture is saved to the data store (see Step 126 in FIG. 1A). A time remaining to score is displayed or presented to the user, such as via audio (see Step 128 in FIG. 1A). If, for example, the VR fails to save to the data store (see Step 126 in FIG. 1A) a command prompt is displayed or presented via audio to the player to reacquire a VR (see Step 124 in FIG. 1A). According to one aspect of the invention, each VR and associated query are given a certain time period for scoring. The time remaining to score may be displayed (see Step 128 in FIG. 1A) for the player to be appraised of the remaining time to receive points to the player's profile (see Step 204 in FIG. 2). By way of example, screenshot 308 in FIG. 3A is a pictorial representation of a time period awarded to a player in accordance with the above-identified processes, functions, and operations of the present invention. According to one embodiment, the time remaining to score (see Step 128 in FIG. 1A) may be allocated based on the difficulty of the query/STEM-related item(s), the correlation between the query/STEM-related item(s) and the acquired VR (e.g., image, photo, video, photograph, etc.), the number of similar or related query/STEM-related items and images in the data store or image bank (see Step 244 in FIG. 2), or other parameters, processes, operations or functions of the present invention.

According to one aspect of the invention, a user, player or operator (collectively a player) may be awarded points when a combination query and VR he or she selected is selected by another player and answered correctly by matching the same query and VR. Furthermore, a player is able to score points by correctly associating a VR or picture with a query or STEM-related element/item in accordance with one or more operations, processes, functions, or parameters in the present invention. For example, a set of photos, pictures or images (collectively photos) from the photo bank 244 shown in FIG. 2 may be displayed (alternatively a VR may be selected from a data store and displayed; see Step 130 in FIG. 1A) on the screen of an electronic device, such as pictorially represented by screenshots 310-312 in FIG. 3B in accordance with one aspect of the invention. The pictures may be presented as a pallet of pictures for example pictures 1-16 as represented by screenshot 310. The screenshots included in the pallet from the data store 126 in one embodiment (see FIG. 1A) or photo bank 244 in another embodiment (see FIG. 2) may be created based on the difficulty of the query/STEM-related item(s), the correlation between the query/STEM-related item(s) and the image, the number of similar related query/STEM-related items in the image bank, or other parameters, processes, operations or functions of the present invention. As previously indicated, the query/STEM-related item(s) may be any item of interest or any real-world item (e.g., artistic, creative, job/skill representations, and group/team behavioral representations). The pictures presented in the pallet of images shown by screenshot 310 may be randomized or randomly selected from the data store 126 in one embodiment or photo bank 244 in another embodiment. According to one aspect of the invention, at least one or more of the pictures presented on the pallet of pictures shown in screenshot 310 are of interest to the player, for example, based upon information in the profile 204 of the player. A picture may be selected from the plurality of pictures by touch or audible command. In another aspect, the pictures (i.e., visual representations of a query) may be video or even audio clips. In at least one use, a player may select picture 7 from the pallet of pictures shown in screenshot 310 or by audible/voice command select image 7. The system determines if a picture has been selected (e.g., VR selected? see Step 132 in FIG. 1A); if not, the set of pictures from the photo bank 244 or VRs from the data store 130 are displayed (see Step 130 in FIG. 1A). If a picture has been selected by the player the system displays a set of queries for the selected VR (see Step 134 in FIG. 1A). According to one aspect, one or more STEM-related elements/items are presented that best relate to the photograph, image or picture selected (see Step 238) as pictorially represented by screenshot 312 in FIG. 3B. As discussed above, the protocol for selecting queries for a selected VR or STEM-related items/elements for a selected picture may be conducted according to one or more of the aforementioned operations, processes, functions, or parameters of the present invention. The player may select (see screenshot 314 and FIG. 3B) the answer or STEM element that best relates to the picture that is presented. In the embodiment shown in FIGS. 1A-B, the player selects a query from the set of queries that he/she believes to be the best VR. The system determines if the correct answer or STEM-related element/item has been selected (see Step 240 in FIG. 2), or in another aspect whether the correct query was selected (see Step 136 in FIG. 1A). If the correct query, answer, STEM-related element or STEM-related item is not selected the system displays, for example, an incorrect query has been selected and that no points have been awarded (see Step 138 in FIG. 1A). Alternatively, depending upon the relationship between the selected query, answer or STEM-related item and the picture presented, the system may be configured to award some or allocate a portion of the available points to the player's profile 204. If the correct query, answer or STEM-related item is selected by the player the system displays, for example, that the correct query was selected and a certain amount of points are awarded (see, for example, Step 140 in FIG. 1A). An exemplary screenshot 316 is provided pictorially in FIG. 3C of points being awarded to a player based upon correctly selecting the query, answer or STEM-related item that best relates to the VR or picture presented to the player. At any time, a player may review the results (see Step 240 in FIG. 2) by going to the player's profile (see, for example, 204 in FIGS. 2 and 148 in FIG. 1B). The above process describes an operation where the player chooses a VR or a picture that they try and guess which of the queries or STEM-related elements presented to them is the query or element that the submissions creator chose when the post was created. A post generally includes one or more items associated with each other through selection or operation by a player. In one aspect, posts include a VR and one or more queries. In another aspect, posts include a photo and one or more items. In still another aspect, posts include images and one or more STEM-related items. Through this process a system of honesty is not only desired but required to win. Players do not compete, but rather are mutually dependent on each other. New content for the data store or photo bank and associated query or STEM-related items are created every time a player plays a new game. According to one aspect, a query or STEM-related item/element is matched with a VR or picture before the user can answer another user's submission (i.e., post). Such a process creates a constant even flow of original content being saved to the data store 130 or image bank 244. A player generally picks from the list of randomized VRs or pictures submitted by others based on how interesting the subject matter is to him or her. Player's choices, preferences and selections could be viewed for subsequent study, research and development of real-world items, various items of interest, and in at least one aspect relevant test question subject matter as illustrated by Step 246 in FIG. 2.

Each submission or post has a set active time limit as described above that depletes unless other players choose the submission and correctly answer. If a player gets the answer correct more time may be added to his or her profile to increment the active time limit for the submission or post to score points to that player's specific profile. Every time a player scores a correct answer for a submission or post the creator of that specific submission may receive points in addition to extra time for the submission to score points to the player's profile. The system may be configured to allow players who cannot make it past higher levels to go back and play on completed levels for equal points. In this way, the system may be configured to provide a leveling feature that creates a way for all players to level up in each difficulty and win prizes and be awarded time upon completion. As previously described, points that are accumulated by a player can be redeemed for items like photo filters, stamps to place on pictures, drawing capabilities, decorative ways of showing off the users favorite pictures, etc. According to another aspect of the invention, all pictures may be viewed on a player's profile 204 or 148. Other users can friend each other and chat about the VRs or pictures taken, the associated queries or STEM-related questions/items, or whatever is on their mind. FIG. 1B provides an exemplary process for awarding points to a user/player for his or her submission or post to the data store 126 or photo bank 244. Upon submission of a VR or picture to the data store 126 or photo bank 244, players are able to select other VRs 132 or pictures 236 from the data store 130 or photo bank 244 and select a query 136 or STEM-related element/item 238 that best represents the selected VR or picture. This means that other players may select user submitted pictures, such as user submitted posts, from the data store 130 or photo bank 244. Each of the player submitted VRs or pictures in the data store 130 or photo bank 244 have, according to one aspect of the invention, an allotted time to score points to the player's profile 148/204 who submitted the post (i.e., the VR/picture and the associated query/STEM-related item.

Screenshot 318 shown in FIG. 3C provides a pictorial representation of a set or pallet of player submitted pictures, such as a pallet of VRs that may be displayed on an electronic device for a player to select from the data store 130 in one aspect of the invention or photo bank 244 in another aspect of the invention. Each of the VRs or pictures, according to one aspect of the invention, are submitted by a player and have an associated query or STEM-related item or element that each is correlated or tied to based upon the player's selection upon submission or posting. Alternatively, the pallet of VRs pictures shown in screenshot 318 may include one or more VRs or pictures uploaded or saved to the data store 130 or photo bank 244 by the system or one or more programmers or operators of the system for purposes of item study, item research and item development, and in one aspect for purposes of STEM-related item/element study, research and development. According to one aspect of the invention, the electronic device and system may be configured to display command prompts 144 shown in FIG. 1B. From the command prompt display 144 a player may select a start play command prompt 120 shown in both FIGS. 1A and 1B. Players alternatively may select the player profile command prompt 146 displaying the player profile 148 or 204 shown in FIG. 2. From the player's profile a player can monitor the time remaining for a post to score points based on it being selected and answered correctly by others. If the time remaining to score is greater than 0 as shown in command prompt 150 the post may continue to score points to the user's profile 204 or score additional time whereby the remaining time is incremented based upon selection by others. For example, points and/or time may be awarded when another player correctly answers a player's post. Screenshot 318 shows a pallet of player submitted pictures or VRs. One or more players, other than the player who submitted the picture or VR, are able to select a VR or picture to which a query or STEM-related element, STEM-related item, or other like word association is provided for the player to review. Screenshot 320 in FIG. 3C provides a pictorial representation of a selected VR/picture and a set of queries/STEM-related items that are associated with the VR/picture by choice of the player who submitted the post. The player selects the query, STEM-related item, STEM-related element, or answer from the set of queries, elements, items, or answers that best relates to the VR/picture shown as provided in screenshot 322. If the player's selection is incorrect, the system may, in one exemplary aspect, be configured to award or allocate only a portion of the available points and/or time or no points or time. Alternatively, in another exemplary aspect, the system may be configured to award a certain amount of points and/or some time based upon balancing between various game embodiments, game difficulty, subject matter, relevancy, frequency, or other like parameters. Awards can based a variety of parameters and considerations, which only a few are discussed herein and only for purposes of providing one or more exemplary operations, processes, functions, or parameters of the present invention. If a player correctly answers a post points and/or time may be awarded to the profile of the player who submitted the post. Screenshot 326 in FIG. 3D provides a pictorial representation of points and time being awarded to the profile of a player for a picture (i.e., a post) that was correctly answered by another. Additionally, the player who provided the correct answer may also be awarded points as pictorially illustrated in screenshot 324. According to one aspect, the system may be configured to display that someone has answered a player's post correctly and award points or increment time for the player's submitted post to score additional time and points (see Step 154 in FIG. 1B). Thus, according to one embodiment, the player's profile and submitted posts may receive points and/or additional time even when the players not playing based upon another player correctly answering the player's submitted posts. At any time, such as at the end of a play, a player may review his/her profile by selecting the player profile command prompt (see Step 156 in FIG. 1B or see Profile 204 in FIG. 2) as pictorially represented in screenshot 328 in FIG. 3D. As discussed, the player's profile 204 may include a player profile image, the points they have scored so far, the time left for a submission to score, the number of attempts, the number of correct answers, and a metric showing how they compare to others by identifying them according to some performance-related categories such as level 1, level 2, level 3, or level 4 as pictorially represented in screenshot 328. Other performance-indicative names or categories may be used depending on the game or game type.

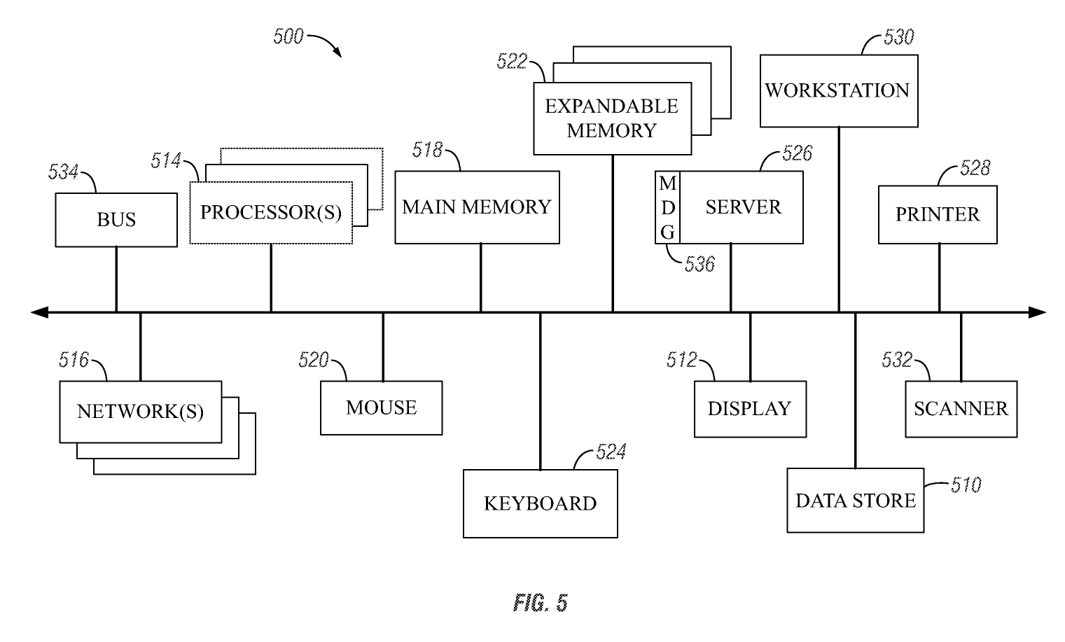

FIG. 5 provides a flow chart diagram for an exemplary process for a mobile device gaming platform of the present invention. Aspects of the invention contemplate interfacing with, displaying and receiving player submitted pictures from a photo bank 244 (see FIG. 2). A work station 530 or multiple work stations, such as the one illustrated in FIG. 5, may be used to perform any one or more the operations, processes, functions, parameters of the present invention. The work station may be a type of electronic device, such as those previously described. In one embodiment, the work station may be an electronic device, such as a camera enabled smart phone or multiple camera enabled smart phones. Using the system 500, any one or more of the operations, processes, functions, and/or parameters of the present invention may be implemented in combination with any one or more of the aforementioned aspects of the invention. As shown, the system 500 may be configured to include, for example, a server 526 or multiple servers, in operable control of one or more operations, processes, functions and/or parameters of the mobile device gaming platform 536, a work station 530 or multiple work stations (e.g., an electronic device such as one or more camera enabled smartphones), a scanner 532 or multiple scanners (e.g., scannable optic function associated with an electronic device), a printer 528 or multiple printers (e.g., wired or wireless capabilities of printing one or more aspects of the game from a device), a data store 510 or multiple data stores for storing one or more pictures in the photo bank 244 or items related to a player profile 204, and other linked network. The computer network may be configured to provide a communication path for each device of the network to communicate with other devices. Additionally, the computer network 500 may be the internet, a public switchable telephone network, a local area network, private wide-area network, wireless network, and any of the like. All or a portion of the computer network 500 may be configured behind an institutional firewall. FIG. 4 provides an exemplary embodiment of a communications network as previously described. In various embodiments, an automated process of the present invention may be operated, at least in part, by one or more operating protocols which may be executed on one or more servers and/or one or more work stations, similar to the work station shown in FIG. 5. For example, in one embodiment or aspect of the invention, the server 526 or multiple servers may be configured to execute a mobile device gaming application on multiple devices using the communication system illustrated in FIG. 4. The display 512 or multiple displays may be used to communicate information to a player as pictorially represented in screenshots 302-328 shown in FIGS. 3A-3D. The scanner 532 or multiple scanners could be configured to perform an optical image acquisition process or protocol associated with one or more elements of the present invention. For example, a camera enabled smartphone may be used to acquire images, pictures or photos which are stored in one or more photo banks 244. The printer 528 or multiple printers may be configured to output any content to a print media, such as paper. Furthermore, data associated with any one or more of the processes, functions, parameters and/or operations of the invention may be stored on one or more data stores 510. The data store may additionally be configured to receive and/or forward some or all of the stored data. Moreover, in yet another aspect, some or all of the computer network 500 or networks may be subsumed within a single device or multiple devices, such as an electronic device. Although a work station is depicted in FIG. 5, it is understood that the invention is not limited to the operation within a computer work station, but rather the invention may be practiced in or on any one or more suitable computer networks or electronic devices, such as one or more camera enabled smartphones. Accordingly, the work station depicted in FIG. 5 is for illustrative purposes only and thus is not meant to limit the present invention in any respect. Other elements of the network may include a main memory 518 or multiple main memories, one or more processors 514, one or more buses 534, and elements of a user interface such as one or more mice 520, one or more keyboards 524, and/or display(s) 512. One or more networks 516 may be configured to operate in conjunction with the system 500 or one or more aspects of the present invention.

The present invention is not to be limited to the particular embodiments described herein. In particular, the present invention contemplates numerous variations in the type of ways in which embodiments of the invention may be applied. The foregoing description has been presented for purposes of illustration and description. It is not intended to be an exhaustive list or limit any of the disclosure to the precise forms disclosed. It is contemplated that other alternatives or exemplary aspects that are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments of the invention disclosed with greater particularity.

What is claimed is:

1. A method for crowd-sourcing one or more items of interest using an electronic device, comprising:
presenting an item query to a player in the form of a prompt via a device;
instructing the player to acquire a visual representation of the item query;
notifying the player of a time period for the visual representation to score; and
awarding points to the player at least in part upon another player matching the visual representation with the item query.

2. The method of claim 1 further comprising:
requesting demographic information from the player for creating a player profile.

3. The method of claim 1 further comprising:
displaying at least one of:
a. a points total for the player;
b. a time remaining for the visual representation to score.

4. The method of claim 1 further comprising:
analyzing the one or more items of interest to determine public bias, perception and misconception using the visual representation of the item query.

5. The method of claim 1 wherein the query is displayed on a mobile device.

6. The method of claim 1 wherein the query comprises one of:
a. an item of interest;
b. a real-world item;
c. a STEM-related item.

7. The method of claim 1 wherein the visual representation is uploaded for display with a plurality of images.

8. A method for matching a visual representation to a prompt with a mobile device, comprising:
creating a player profile;
reviewing a query provided via a mobile device;
capturing an visual representation of the query with the mobile device; and
receiving an incremental increase in a time remaining for scoring when the query and the visual representation are matched by another player.

9. The method of claim 8 further comprising:
displaying the query on the mobile device.

10. The method of claim 8 further comprising:
monitoring a time remaining for scoring points in the player profile.

11. The method of claim 8 further comprising:
receiving points when the query and the visual representation are matched by another player.

12. The method of claim 8 further comprising:
receiving an initial time allotment for scoring upon acquiring the visual representation.

13. The method of claim 8 further comprising:
reviewing a plurality of visual representations, selecting one visual representation from the plurality of visual representations and matching a query with the selected visual representation from the plurality of visual representations.

14. A mobile game for matching a visual representation to a query, comprising:
a query displayed to a player in the form of a prompt via a device;
an image representative of the query acquired by the player;
a time period for the image to score allocated to the player; and
one or more points awarded to the player at least in part upon another player matching the visual representation with the query.

15. The mobile game of claim 14 wherein the query comprises one of:
a. an item of interest;
b. a real-world item;
c. a STEM-related item.

16. The mobile game of claim 14 further comprising:
a player profile with a player score from the one or more points awarded to the player.

17. The mobile game of claim 14 further comprising:
a player profile with the time remaining for the visual representation to score.

18. The mobile game of claim 14 wherein the visual representation comprises one of:
a. a photograph;
b. a video.

19. The mobile game of claim 14 wherein an image of the visual representation is uploaded for display in another player's game.

20. The mobile game of claim 14 wherein the device comprises a mobile device.
